(19) United States
(12) Patent Application Publication
(10) Pub. No.: US 2012/0120509 A1
(43) Pub. Date: May 17, 2012

(54) Apparatus Of Auto-Focus Module And Assembly Method Thereof

(76) Inventors: Chin-Sung Liu, Hsinchu (TW); Chien Chung Pien, Taipei (TW); Tsung Kai Chang, Hsinchu (TW); Yi Jung Chen, Yunlin (TW); Yung Fu Huang, Hsinchu (TW); Shin Ter Tsai, Taipei (TW)

(21) Appl. No.: 12/418,586

(22) Filed: Apr. 4, 2009

(51) Int. Cl. G02B 7/09

(52) U.S. Cl. 359/824

(57) ABSTRACT

An apparatus of auto-focus module and the related assembly method are provided. The module includes a focus-driving module and a photo-sensor module. The focus-driving module includes a lens set and a focus-driving device. The outer circumference of the lens is a smooth surface and the inner circumference of the lens holder is also a smooth surface. The assembly method includes the steps of: sheathing the lens into the lens holder of the focus-driving device and fastening the lens to the lens holder to form a focus-driving module; maintaining a gap as the space for adjusting the locations of the focus-driving module and the photo-sensor module, and after adjustment, fastening the focus-driving module and the photo-sensor module.

### FIELD OF THE INVENTION

The present invention generally relates to an apparatus of auto-focus module and the assembly method thereof.

### BACKGROUND OF THE INVENTION

FIG. 1 shows a schematic view of the structure of conventional driving component and photo-sensor component, and FIG. 2 shows a flowchart of assembly method for assembling conventional driving component and photo-sensor component, respectively. As shown in FIG. 1, the structure of FIG. 1 includes a lens holder 11, a driving component 12, a sensor component 13, and a lens 14. The assembly method includes the steps of:
Step 21: installing lens holder and driving component, by installing lens holder 11 onto driving component 12;
Step 22: fixing driving component and sensor component, by fixing driving component 12 onto sensor component 13; and
Step 23: installing lens and adjusting focus, by installing lens 14 into lens holder 11, screwing the outer screw-teeth 141 of lens 14 into inner screw-teeth 111 of lens holder 11, and performing focus adjustment.

The disadvantages of the above assembly method include that (1) when the screw-teeth of the lens and the lens holder are too loosely coupled, glue is required for fastening; (2) when the screw-teeth of the lens and the lens holder are to tightly coupled, it will cause damage to the suspension system of the driving component; and (3) it is difficult and costly to made the mold for the screw-teeth. In general, the friction between the screw-teeth of lens and the lens holder may generate small debris or metal dust to fall upon the photo-sensor component so as to affect the optical quality.

### SUMMARY OF THE INVENTION

The present invention provides an auto-focus module and the assembly method thereof. The module includes a focus-driving module and a photo-sensor module. The focus-driving module includes a lens set and a focus-driving device. The outer circumference of the lens is a smooth surface and the inner circumference of the lens holder is also a smooth surface. The assembly method includes the steps of: sheathing the lens into the lens holder of the focus-driving device and fastening lens to the lens holder to form a focus-driving module; and maintaining a gap as the space for adjusting the locations of focus-driving module and the photo-sensor module, after adjustment, fastening the focus-driving module and the photo-sensor module.

The assembly method sheathes the smooth surface of the lens into the smooth surface of lens holder and then fastens both, instead of the conventional screw-teeth approach so as to reduce the manufacturing cost and the assembly time to improve the competitiveness.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the structure of conventional driving component and photo-sensor component;

FIG. 2 shows a schematic view of the flowchart of an assembly method of the conventional driving component and photo-sensor component;

FIGS. 3A-3C show a schematic view of an auto-focus apparatus of the present invention; and

FIG. 4 shows a flowchart of the assembly method of the present invention.

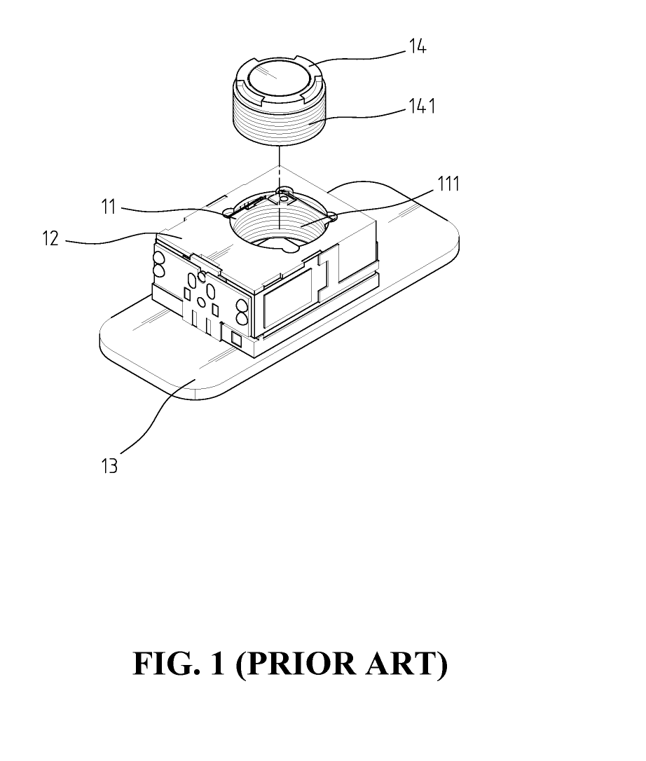

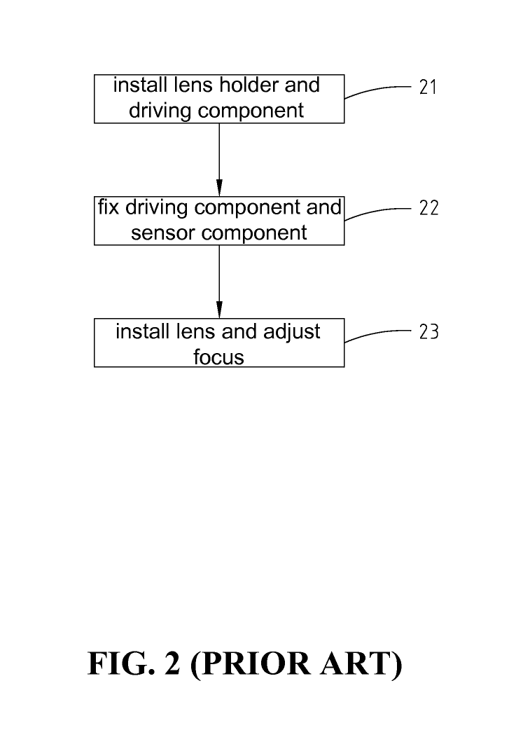

### DETAILED DESCRIPTION OF THE PREFERRED EMBODIMENTS

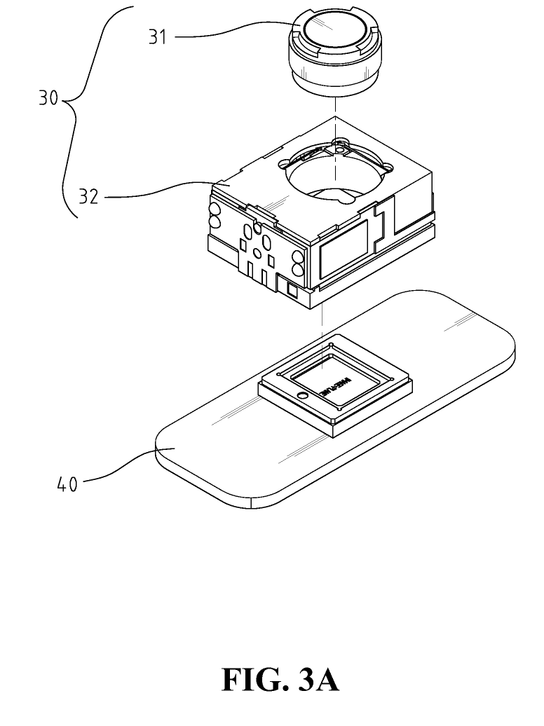

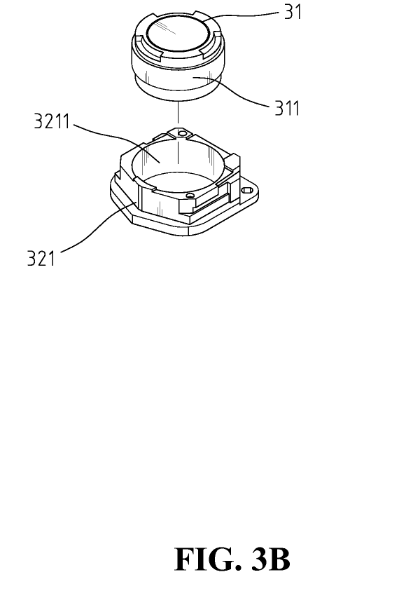

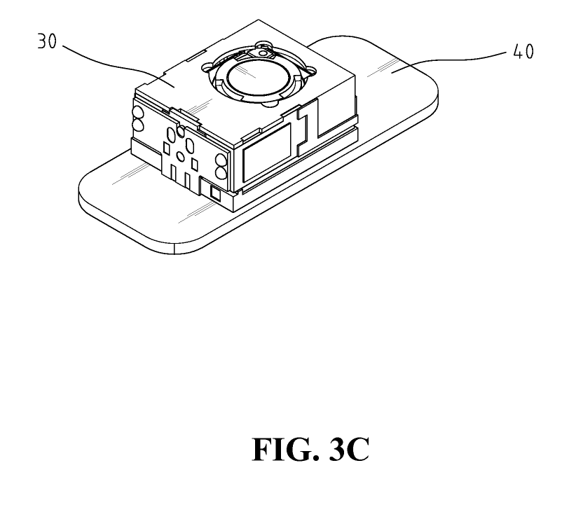

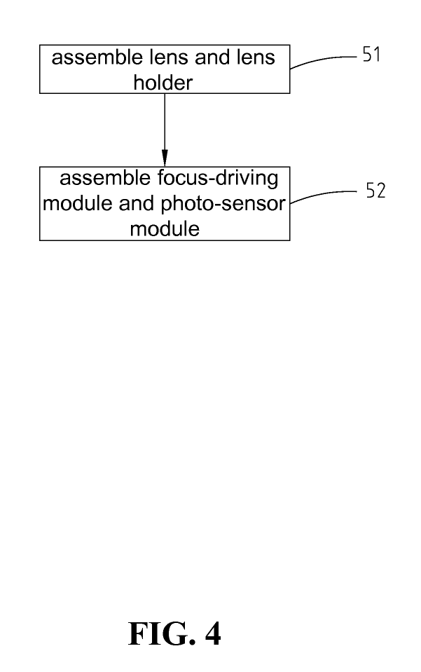

FIGS. 3A-3C show a schematic view of the auto-focus module, and FIG. 4 shows the assembly method of the present invention. An auto-focus module of the present invention includes a focus-driving module 30 and a photo-sensor module 40. Focus-driving module 30 further includes a lens set 31 and a focus-driving device 32. The outer circumference of lens set 31 is a smooth surface 3111. Focus-driving device 32 further includes a lens holder 321 with an inner circumference that is a smooth surface 3211.

The assembly method of the present invention includes the steps of:
Step 51: assembling lens and focus-driving device, by sheathing lens 311 into lens holder 321 of focus-driving device and fastening with a glue dot to form a focus-driving module 30; and
Step 52: assembling focus-driving module and photo-sensor module, by installing focus-driving module 30 onto photo-sensor module 40, maintaining a small gap between focus-driving module 30 and photo-sensor module 40 and utilizing an optical adjustment equipment to use a suspension manner for space adjustment and focus adjustment, and finally using glue dot to fasten focus-driving module 30 to photo-sensor module 40.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An apparatus of auto-focus module, comprising:
a focus-driving module having a focus-driving device and a lens set, said focus-driving device including a lens holder having an inner circumference formed with a smooth surface, said lens set having an outer circumference formed with a smooth surface, and said lens set being sheathed into and fixedly received within said lens holder; and
a photo-sensor module, said focus-driving module being installed on said photo-sensor module.

2. (canceled)

3. The apparatus as claimed in claim 1, wherein said lens set is glued to said lens holder by using a glue dot.

4. A method of assembling an auto-focus module, comprising the steps of:
preparing a lens set having an outer circumference formed with a smooth surface and a focus-driving device including a lens holder having an inner circumference formed with a smooth surface;
sheathing said lens set into said lens holder and fixing said lens set within said lens holder with a glue dot to form a focus-driving module;
installing said focus-driving module onto a photo-sensor module by maintaining a small gap between said focus-driving module and said photo-sensor module for space and focus adjustment with a suspension manner utilizing an optical adjustment equipment; and
fixing said focus-driving module to said photo-sensor module to assemble said auto-focus module.
